(19) United States
(12) Patent Application Publication
(10) Pub. No.: US 2023/0072752 A1
(43) Pub. Date: Mar. 9, 2023

(54) SYSTEM AND METHOD FOR AN AUTOMATED SELF-SERVICE SUPPORT DESK

(71) Applicant: Villani Analytics, LLC., Scarsdale, NY (US)

(72) Inventor: Daniel A. Villani, Scarsdale, NY (US)

(73) Assignee: Villani Analytics, LLC., Scarsdale, NY (US)

(21) Appl. No.: 17/466,138

(22) Filed: Sep. 3, 2021

(51) Int. Cl. G06Q 10/06; G06F 16/2455; H04L 29/06

(52) U.S. Cl. CPC G06Q 10/063114; G06F 16/2455; H04L 63/083; H04L 63/105

(57) ABSTRACT

A system includes a computing device connected to a self-service support desk platform via a communication channel. The platform receives a selection of a predefined service request, an execution date for the predefined service request and information regarding a rationale for submitting the predefined service request. The platform automatically creates a support ticket that comprises the information and assigns the support ticket to a group. If approval is required for execution of an action associated with the support ticket, the support ticket is automatically directed to an approver. After receiving the approval, the execution of the action is automatically scheduled for the execution date and is executed on the execution date.

### FIELD OF THE EMBODIMENTS

The field of the invention and its embodiments relate to a system and a method for an automated self-service support desk.

### BACKGROUND OF THE EMBODIMENTS

Technical support services and programs are designed to diagnose and solve hardware or software problems that users and/or customers encounter as they use computers. Traditional technical support centers place an emphasis on internal tracking and productivity tools, such as problem tracking systems. Such “back end” systems exist internally to the support organization. Although back-end systems aid internal efficiency, they do little for the actual problem resolution process itself. Problem resolution is typically left to telephony-based technologies, such as agent-based automatic call distribution (ACD) support centers. In fact, the most common method of technical support is still a telephone conversation with a technical support personnel.

Further, traditional support ticketing systems do not depict the status of automated jobs and do not capture an automated job history. Traditional job scheduling platforms also do not grant access to end users. In traditional systems, end users only receive email notifications on the successes and failures for jobs.

However, what is needed is a system that includes an automated self-service support desk that allows a user to receive instantaneous support 24/7 without having to create a support ticket, wait for a person to claim the ticket, and then wait for the person to perform the work.

### Review of Related Technology

US6999990B1 and US6615240B1 describe a method for automated technical support in a computer network having a client machine and at least one server from which live help is available. The method begins by initiating a guided self-help session in response to entry by a user of a problem area and description. During the self-help session, the user is provided with an option to escalate to live help. If the user exercises that option, the system automatically provides a support engineer at the server with a data stream summarizing the self-help session. During the live help, the support engineer may then repeat a portion of the user’s self-help session, view information generated during that session, and/or execute certain actions with respect to the user’s machine, all from the engineer’s desktop. An active journal is maintained for each problem incident, and active journals may be used by other analysts to facilitate problem resolutions for new incidents.

US6694314B1 describes a method for automated technical support in a computer network having a client machine and at least one server from which live help is available. The method begins by a user entering a description of a problem. In response, a diagnostic map is executed to explore the user’s machine and the problem description. The map returns a self-help search string that, upon execution in a search engine, is expected to return relevant search results. The search string may then be executed to facilitate a guided self-help session.

US6477531B1 describes a method for automated technical support in a computer network having a client machine and at least one server. In response to entry by a user of a problem description, a method is initiated. During a guided self-help session, the user is presented with active content, for example, technical support information that may be “activated” via a diagnostic map. A given diagnostic map encapsulates a set of one or more methods that, upon execution, explore the user’s machine and gathers diagnostic data. The active content is useful to facilitate diagnosis or self-repair during the self-help session.

US6658598B1 describes guided self-help, which is facilitated through use of “active content” pages that are selectively filtered and retrieved as a function of a set of declarative “assertions.” An assertion typically is an individual statement or building block of a larger, more comprehensive diagnostic map. An assertions map is a smaller, more focused version of a diagnostic map that is executed against a user’s computer system to diagnose a particular problem situation that the user has encountered. When a user encounters a technical problem, he or she navigates to a search window and enables a given command when entering a search string to identify fixes for the problem. A server process responds to the search request and downloads an assertions map that checks the state of the end user system and returns results. The server process then processes the conditions, filters content that matches conditions on the end user system, and ranks and displays search results to the relevant active content based on a hierarchy of assertion results.

US6542898B1 describes a method of guided self-help facilitated through use of so-called “active content” pages that are selectively viewable by given “audiences” within a technical support chain automation system. Active content is Web-based content (e.g., content viewable by a Web browser) that has one or more diagnostic maps initiated when certain actions are taken. According to the invention, users are assigned to a hierarchy of audiences. A given audience within the hierarchy has the right to view active content written for that audience and active content written for any audience within the hierarchy at a lower level in the hierarchy. Given segments or portions of an active content database are associated with given audiences in the hierarchy. Thus, during a guided technical support session initiated by a user, given active content is served to the user as a function of the audience to which the user has been assigned.

US10182156B2 describes insight-based routing that is used to improve processing of a service request through a help desk service. A request for support (e.g. technical support) can be received through a modality of a help desk service. The request is evaluated, where an evaluation of the request comprises analyzing an issue associated with the request, as well as user-specific signal data associated with a customer and generating insights. A support agent is matched to the customer based on an evaluation of the request. The support agent is selected from a pool of support agents based on application of a model that analyzes support agent data in correlation with the generated insights. An interaction between the matched support agent and the customer may be initiated through a modality of the help desk service.

GB2561973A describes methods for facilitating task automation at an IT service desk. The method comprises: provisioning a user interface (UI) to enable the user to provide a natural language request, a virtual agent engaging in a natural language interaction and interpreting the request. The interpretation is mapped to a set of pre-determined actions to be executed to facilitate resolution of the request. Interpretation may be based on learning and stored in a knowledge base, which may be supplemented by publicly available information such as forums. Context of the request may be determined from user identity, whether approvals are required to resolve the request and, if so, identity of an approver. The virtual agent may interact with the approver to obtain approval. The helpdesk may connect with service applications and log entries corresponding to executed actions for compliance and audit requirements. The UI may be voice, chat or messaging based.

US20180218305A1 describes a method and a system for facilitating task automation at an IT service desk associated with an enterprise. A user interface is provisioned to a user to enable the user to provide a request in a natural language form to the IT service desk. A virtual agent engages in a natural language interaction with the user on the UI and interprets the request from the natural language interaction. The request is mapped to a set of pre-determined actions based on the interpretation of the request and an execution of the set of pre-determined actions is effected to facilitate resolution of the request provided by the user.

US8135612B1 describes systems and methods for automating the assignment of digital help-desk requests. A request analyzer module analyzes the content of the digital help-desk request. A task load monitor module analyzes the help-desk resource availability and suitability. A help-ticket assignment module generates a help ticket based on the digital help-desk request and assigns the help ticket to a resource based upon the analysis of the request and the analysis of resource availability and suitability. The system may also estimate a time to respond to the request based upon an analysis of the assigned resources capabilities and status.

Various systems exist in the art. However, their means of operation are substantially different from the present disclosure, as the other inventions fail to solve all the problems taught by the present disclosure.

### SUMMARY OF THE EMBODIMENTS

The present invention and its embodiments relate to a system and a method for an automated self-service support desk.

A first embodiment of the present invention describes a system. The system includes a computing device, a communication channel, and a self-service support desk platform. The computing device includes one or more processors, one or more memories, one or more computer-readable hardware storage devices, and a graphical user interface (GUI) configured to receive an action from a user to access the self-service support desk platform. It should be appreciated that the communication channel connects the computing device and the self-service support desk platform.

The self-service support desk platform is configured to receive a selection, from a user, of a predefined service request, an execution date for the predefined service request, and optionally information regarding a rationale for submitting the predefined service request. The self-service support desk platform automatically creates a support ticket that optionally comprises the information and assigns the support ticket to a system group to respond to the support ticket.

In response to a determination that approval is required from an approver for execution of an action associated with the support ticket, the self-service support desk platform automatically directs the support ticket to the approver and notifies the approver that such approval is required. In response to a determination that the approver failed to approve execution of the action associated with the support ticket, the self-service support desk platform closes the support ticket automatically with a message that the action associated with the support ticket was not approved.

In response to receiving the approval from the approver, the self-service support desk platform automatically schedules the execution of the action associated with the support ticket for the execution date. The execution date for the predefined service request is a current time and date or may be a future time and date. On the execution date, the self-service support desk platform executes the action associated with the support ticket. In response to a determination of a successful completion of the action, the self-service support desk platform updates and closes the support ticket. In response to a determination of an unsuccessful completion of the action, the self-service support desk platform automatically updates the support ticket as having failed, determines a location where the action failed, and assigns the support ticket to a group associated with the location where the action failed.

In examples, the GUI of the computing device is further configured to: receive login credentials from a user and query a database to determine an identity of the user and an access level to the self-service support desk platform for the user based on the login credentials. The identity of the user is a customer or an administrator. The access level comprises a first access level or a second access level. The second access level is greater than the first access level such that the second access level provides the user a larger number of actions with respect to the self-service support desk platform as compared to the first access level.

In some examples, the GUI of the computing device is further configured to receive a request from the user to search support tickets via the self-service support desk platform. A subset of the support tickets comprise a Service Level Agreement (SLA).

In other examples, the self-service support desk platform further comprises a self-service reporting dashboard. The user is configured to engage the self-service reporting dashboard to view information, such as, a status of an action in progress, an action history, a status of a support ticket, and/or a history associated with the support ticket, among other information not explicitly listed herein.

A second embodiment of the present invention describes a method executed by a system. The system includes a computing device, a communication channel, and a self- service support desk platform. The method comprises numerous process steps, such as: receiving, via a graphical user interface (GUI) of the computing device, an action from a user to access a self-service support desk platform. It should be appreciated that the communication channel that connects the computing device and the self-service support desk platform.

The method also includes: receiving, via the self-service support desk platform and from the user, a selection of a predefined service request; receiving, via the self-service support desk platform and from the user, an execution date for the predefined service request and information regarding a rationale for submitting the predefined service request; automatically creating, via the self-service support desk platform, a support ticket that comprises the information; and assigning, via the self-service support desk platform, the support ticket to a system group.

In response to a determination that approval is required from an approver for execution of an action associated with the support ticket, the method further includes: automatically directing, via the self-service support desk platform, the support ticket to the approver; and notifying, via the self-service support desk platform, the approver that the approval is required.

In response to a determination that the approver failed to approve execution of the action associated with the support ticket, the method further comprises: closing, via the self-service support desk platform, the support ticket automatically with a message that the action associated with the support ticket was not approved. In response to receiving the approval for execution of the action associated with the support ticket, the method further includes: automatically scheduling, via the self-service support desk platform, the execution of the action associated with the support ticket for the execution date.

On the execution date, the method includes executing, via the self-service support desk platform, the action associated with the support ticket. Further, in response to a determination of a successful completion of the action, the method includes: updating and closing, via the self-service support desk platform, the support ticket. In response to a determination of an unsuccessful completion of the action, the method further comprises: automatically updating, via the self-service support desk platform, the support ticket as having failed; determining, via the self-service support desk platform, a location where the action failed; and assigning, via the self-service support desk platform, the support ticket to a group associated with the location where the action failed.

In some examples, the user is an administrator. In these examples, the method further includes: receiving, from the administrator and through an administrator action builder of the self-service support desk platform, a creation of a new action; receiving, from the administrator and through the administrator action builder, security settings for the new action; and determining if the administrator is using a predefined template for the new action. In response to a determination that the administrator is using the predefined template for the new action, the method further comprises: pre-populating, through the administrator action builder, system properties and receiving, from the administrator, additional properties.

The method also includes: determining, via the administrator action builder, if an approval is required for the new action. In response to a determination that the approval is not required for the new action, the method includes: receiving, from the administrator and through the administrator action builder, pass/fail notification criteria. Additionally, in response to a determination, from the administrator and through the administrator action builder, that the new action is to be saved as a template, the method includes: saving the new action as the template.

In response to a determination that the administrator is not using the predefined template for the new action, the method includes receiving, from the administrator and through the administrator action builder, a supporting scripting language for the new action. The method also includes: receiving, from the administrator and through the administrator action builder, definitions of parameters for the new action; and receiving, from the administrator and through the administrator action builder, logic to create the new action and libraries and executables to support the new action.

In examples, the method may also include: building, by the administrator and through an action dashboard builder, action/workflow dashboards for end users to use to request action/workflow execution.

In general, the present invention succeeds in conferring the following benefits and objectives.

It is an object of the present invention to provide a centralized system for users to place requests and monitor all jobs performed.

It is an object of the present invention to provide a platform that is an all-in-one service desk system.

It is an object of the present invention to provide a platform through which end users may request predefined jobs, view action/job history, and view the upcoming scheduling of jobs, while having auditable results so that the user can view every request made in the system.

It is an object of the present invention to provide a system that has the ability to receive instantaneous support 24/7 without having to create a support ticket, wait for a person to claim the ticket, and then wait for the person to perform the work.

It is an object of the present invention to provide a system that has the ability to monitor, in real-time, the status of requests, as well as actions being performed, without having to dig through email notifications on whether a job has been completed.

It is an object of the present invention to provide a system that audits all changes to a technology system along with the person who requested the change(s).

It is an object of the present invention to provide a system that receives targeted notifications if a job failed, rather than a generic email blast to all system administrators.

It is an object of the present invention to provide a system that defines approval processes so that support tickets get approved before being assigned to support agents, which minimizes the time a support agent needs to wait before being able to work on a support request.

It is an object of the present invention to provide a system that automates common service requests to minimize the number of tickets sitting in a support agents’ queue, which improves customer service since routine requests can be pushed through with minimal to no human intervention.

It is an object of the present invention to provide a system that minimizes service ticket status requests from users with a self-service dashboard.

### BRIEF DESCRIPTION OF THE DRAWINGS

FIG. 1A depicts a schematic diagram of a system, in accordance with embodiments of the present invention.

FIG. 1B depicts a schematic diagram of several components of a system, in accordance with embodiments of the present invention.

FIG. 1C depicts a schematic diagram of several components of a system, in accordance with embodiments of the present invention.

FIG. 2 depicts a schematic diagram of process steps associated with a self-service support desk, in accordance with embodiments of the present invention.

FIG. 3 depicts a schematic diagram of process steps associated with a self-service reporting dashboard, in accordance with embodiments of the present invention.

FIG. 4A depicts a schematic diagram of process steps associated with an administrator action builder of a system, in accordance with embodiments of the present invention.

FIG. 4B is a continuation of FIG. 4A and depicts a schematic diagram of process steps associated with the administrator action builder of the system, in accordance with embodiments of the present invention.

FIG. 5A depicts a schematic diagram of process steps associated with an action dashboard builder of a system, in accordance with embodiments of the present invention.

FIG. 5B is a continuation of FIG. 4A and depicts a schematic diagram of process steps associated with the action dashboard builder of the system, in accordance with embodiments of the present invention.

FIG. 6 depicts a schematic rendering of a user interface of a system where a user can request various actions to be performed, in accordance with embodiments of the present invention.

FIG. 7 depicts a schematic rendering of action approval in a system, in accordance with embodiments of the present invention.

FIG. 8 depicts a schematic rendering of action reporting in a system, in accordance with embodiments of the present invention.

FIG. 9 depicts a schematic rendering of an action workflow builder in a system, in accordance with embodiments of the present invention.

FIG. 10 depicts a block diagram of a computing device included within the computer system of FIG. 1 that is configured to implement one or more methods, in accordance with embodiments of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

A self-service support desk is described herein. In general, self-service support desk is a platform that automates many manual tasks that a human support agent goes through. For example, the self-service support desk of the present invention simulates the end-to-end process that customers or end-users typically go through and eliminates manual steps and the coordination required to complete a task. Further, the self-service support desk of the present invention is customizable to meet the needs of different business requirements with little to no coding.

The system described herein provides numerous benefits to the end-user over traditional systems. For example, the present invention provides (1) a centralized system for users to place requests and monitor all jobs performed, (2) the ability to receive instantaneous support 24/7 without having to create a support ticket, wait for a person to claim the ticket, and then wait for the person to perform the work, (3) the ability to monitor, in real-time, the status of a request, as well as the actions being performed, without having to dig through email notifications on whether a job completed, (4) the ability to audit all changes to a technology system along with the person who requested the change(s), and (5) the ability to receive targeted notifications if a job failed rather than a generic email blast to all system administrators.

Further, the instant system provides numerous benefits to system administrators, such as, but not limited to, (1) the ability to define approval processes so that tickets get approved before being assigned to support agents, which minimizes the time a support agent needs to wait before being able to work on a support request. Further, the instant system provides (2) the ability to automate common requests to minimize the number of tickets sitting in a support agents’ queue, which will improve customer service since the routine requests can be pushed through with minimal to no human intervention. Additionally, the instant system (3) minimizes the status requests from the user.

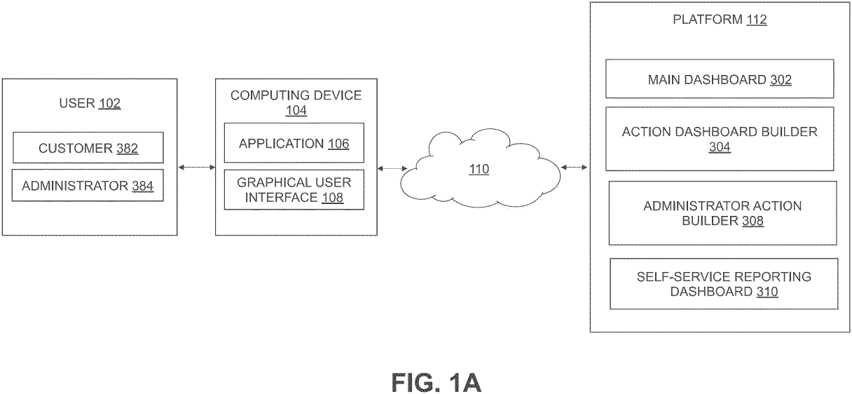

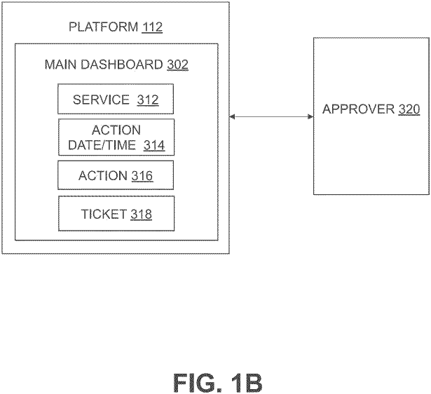

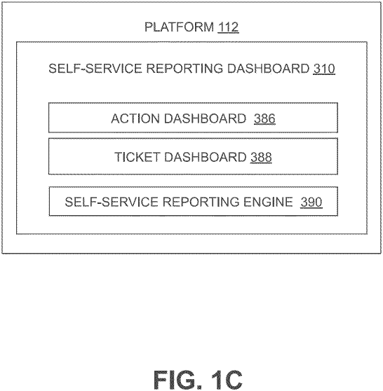

As shown in FIG. 1A, a system described herein includes a computing device 104. The computing device 104 may be a computer, a laptop computer, a smartphone, and/or a tablet, among other examples not explicitly listed herein. The computing device 104 of FIG. 1A may comprise an application 106. In other examples, the application 106 of FIG. 1A may be an engine, a software program, or a service configured to be executable on the computing device 104. A user 102 may engage with a graphical user interface (GUI) 108 of the computing device 104 to access the application 106. Through the application 106, the user 102 may access a web server platform 112 (or the self-service support desk).

Specifically, the computing device 104 is connected to the web server platform 112 via a communication channel 110. The present invention assumes that the user 102 of the computing device 104 has experienced a problem and desires automated technical support. For illustrative purposes, the communication channel 110 is the public Internet, an intranet, an extranet or any other known network connection. The web server platform 112 is one of a plurality of servers which are accessible by clients, such as the computing device 104. The web server platform 112 supports files in the form of hypertext documents, graphics and other data type objects. The network path to a server (or to a file on the server) is identified by a Uniform Resource Locator (URL), and is well-known.

A representative web server platform 112 comprises a computer running an operating system and a web server program that supports interface extensions. The web server platform 112 also includes a display supporting a GUI for management and administration, and an application programming interface (API) to enable application developers to extend and/or customize the core functionality thereof through software programs such as servlets, CGI scripts, helper programs and plug-ins.

Specifically, as shown in FIG. 1A, the web server platform 112 may include numerous dashboards, such as a main dashboard 302, an action dashboard builder 304, an administrator action builder 308, and/or a self-service reporting dashboard 310, among others not explicitly listed herein.

It should be appreciated that when the user 102 accesses the application 106, the user 102 may be prompted to input login credentials. The login credentials may include a username, a password, a biometric identification means (e.g., fingerprint identification, face recognition identification, palm print identification, iris recognition, retina recognition, etc.), etc., or any other type of login credentials. When the login credentials are entered, the application 106 may query a database or repository (not shown) to determine an identity of the user 102 and an access level to the web server platform 112 for the user 102.

For example, the user 102 may be identified as a customer 382 or an administrator 384. The access level of the user 102 determines which actions the user 102 can perform with respect to the web server platform 112. As an example, the access level may be a first access level or a second access level. The second access level is greater than the first access level. Further, the second access level provides the user a larger number of actions with respect to the web server platform 112 as compared to the first access level.

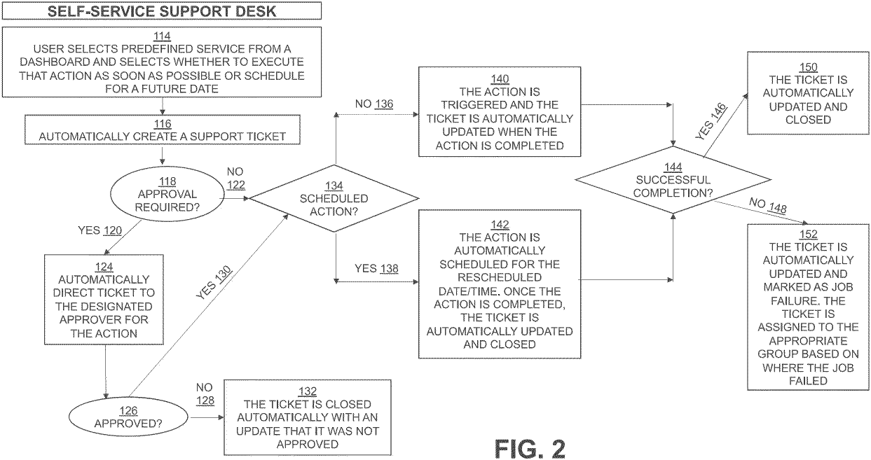

FIG. 2 depicts process steps associated with the self-service support desk or the web server platform 112. As shown in FIG. 2, a process step 114 first occurs, where the user 102 selects a predefined service (e.g., a service 312 of FIG. 1B) from a dashboard (such as the ones depicted in FIG. 1A) and selects whether to execute that action (e.g., an action 316 of FIG. 1B) as soon as possible or schedule the action (e.g., the action 316) for a future date and time (e.g., the action date/time 314 of FIG. 1B or an “execution date”). At this process step, the user 102 can enter applicable notes, such as the rationale for submitting the request. However, it should be appreciated that the entering of applicable notes is optional is not required by the system. Any information entered by the user 102 is auditable so that user 102 can understand what changes have been made to their system and why those changes were requested/made.

A process step 116 follows the process step 114 and includes the web server platform 112 automatically creating a support ticket (e.g., a ticket 318 of FIG. 1B). The support ticket (e.g., the ticket 318) includes the information from the process step 114. Further, during the process step 116, the support ticket (e.g., the ticket 318) is assigned to a system group for actions that will be automatically completed by the software. All support tickets are searchable via the web server platform 112 so that the user 102 can see the status of a given request in real-time. Manually created service tickets can be configured to have Service Level Agreements (SLAs) so that the support ticket (e.g., the ticket 318) is escalated if the specified time has elapsed. As described herein, an SLA is a commitment between a service provider and a client.

Next, a process step 118 follows the process step 116 and inquires whether approval is required for the given action (e.g., the action 316). The approval can be dependent on the action (e.g., the action 316) or can be based on selections that the user 102 makes within the action (e.g., the action 316). A “YES” response 120 or a “NO” response 122 follows the process step 118.

If the “YES” response 120 follows the process step 118, the method moves onto a process step 124, where the ticket (e.g., the ticket 318) is automatically directed to a designated approver (e.g., an approver 320 of FIG. 1B) for the given action (e.g., the action 316). Further, the designated approver (e.g., the approver 320) is notified that approval is required. The action (e.g., the action 316) will not be performed by the system until the approver (e.g., the approver 320) approves the action (e.g., the action 316).

If the “NO” response 122 follows the process step 118, the system will move onto a process step 134, which inquires as to whether the user 102 indicated to have the action (e.g., the action 316) completed as soon as possible (ASAP) or on a schedule (e.g., the execution date and time). A “YES” response 138 or a “NO” response 136 follows the process step 134.

If the YES’ response 138 follows the process step 134, a process step 142 occurs where the action (e.g., the action 316) is automatically scheduled for the scheduled date and time or the execution date and time. Once the action (e.g., the action 316) is completed, the ticket (e.g., the ticket 318) is automatically updated and closed. If the “NO” response 136 follows the process step 134, a process step 140 occurs where the action (e.g., the action 316) is triggered and the support ticket 318 is automatically updated when the action (e.g., the action 316) is completed.

Further, a process step 126 follows the process step 124. The process step 126 inquires whether the support ticket 318 has been approved. At the process step 126, the approver 320 can select between the following actions: approve request or reject request. A “YES” response 130 or a “NO” response follows the process step 126.

If the “YES” response 130 follows the process step 126, the method moves onto the process step 134, as discussed. If the “NO” response follows the process step 126, the method moves onto a process step 132, where the support ticket 318 is closed automatically with an update that it was not approved. Further, at the process step 132, the user 102 who submitted the request will be notified via one or more methods (e.g., email, text message, telephone call, etc.) that no action will be taken because the request was rejected.

Further, as shown in FIG. 2, a process step 144 follows the process step 140 or the process step 142. The process step 144 inquires whether the action (e.g., the action 316) was completed successfully. A “YES” response 146 or a “NO” response 148 follows the process step 144. If the “YES” response 146 follows the process step 144, a process step 150 occurs where the support ticket 318 is automatically updated and closed. If the “NO” response 148 follows the process step 144, a process step 152 occurs, where the support ticket 318 is automatically updated and marked as “job failure.” Further, the support ticket 318 is assigned to the appropriate group based on where the job failed.

It should be appreciated that the information described herein (e.g., the ticket status, the approval required, the successful or unsuccessful completion of the ticket, etc.) may be saved directly in web server platform 112 or may be saved in another database or repository (not shown).

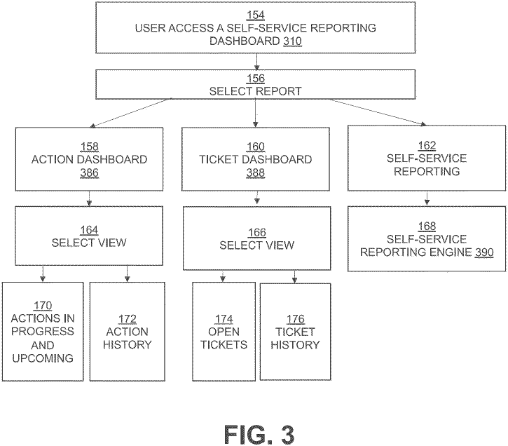

FIG. 3 depicts process steps that occur when the user 102 accesses the self-service reporting dashboard 310 of the web server platform 112. As shown, at a process step 154, the user 102 can access the self-service reporting dashboard 310 to view information, such as the status of actions in progress, action history, ticket status and history or a self-service reporting engine 390. Moreover, at a process step 156, the user 102 can select a report type from the action dashboard 386 (at a process step 158), the ticket dashboard 388 (at a process step 160) or directly from the self-service reporting dashboard 310 (at a process step 162). The action dashboard 386, the ticket dashboard 388, and the self-service reporting dashboard 310 are also depicted in FIG. 1C.

If the user 102 selects the action dashboard 386 (at the process step 158), the user 102 can further select the type of reporting to perform (at a process step 164). The user 102 can also choose to see any actions/workflows that are currently in progress or scheduled for a future date/time (at a process step 170). Here, the user 102 can ensure that scheduled processes have been set and can be made aware of any scheduled downtime. The user 102 can also choose to see action/workflow history (at a process step 172) to become aware of any changes that have been made to the system over a specified time period.

Moreover, if the user 102 accesses the ticket dashboard 388 (at the process step 160), the user 102 can select a view at a process step 166 to view open tickets (at a process step 174) or ticket history (at a process step 176).

Further, if the user 102 wishes to interact directly with the self-service reporting dashboard 310 at the process step 162, the user 102 may build his/her own reports using a self-service reporting engine 390 at a process step 168. The self-service reporting engine 390 is a low code platform that allows the user 102 to put together more advanced queries, such as SLAs, how many tickets were completed within the SLA window, average time to complete tickets, average time to complete actions, last n number of actions performed in the past week, etc.. This service reporting engine 390 will allow the user 102 to drag and drop metrics and filters so that the user 102 does not have to write custom query language scripts to get the data that is needed.

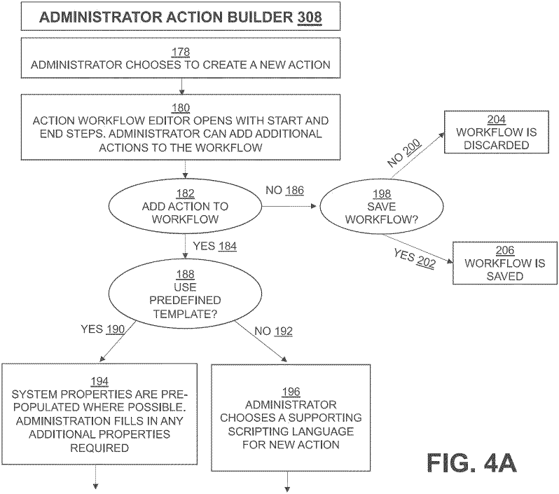

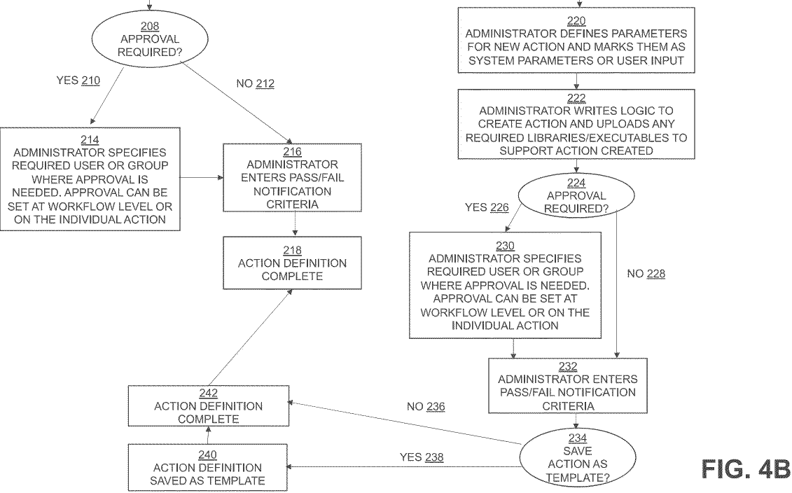

FIG. 4A and FIG. 4B depict actions performed when the administrator 384 accesses the administrator action builder 308. It should be appreciated that FIG. 4B is a continuation of FIG. 4A. The administrator 384 can define actions and workflows available for end users (e.g., customers 382) to request. From the administrator menu, there is a selection for the administrator 384 to build and edit actions/workflows. When the administrator 384 chooses to create a new action at a process step 178, an action workflow editor opens at a process step 180. From here, the administrator 384 can set up some workflow-level settings, such as security. The administrator 384 can also specify which users/groups can request execution of this workflow. Once workflow-level settings are configured, the administrator 384 can choose to add additional actions into the workflow at a process step 182.

A “YES” response 184 or a “NO” response 186 follow the process step 182. If the “YES” response 184 follows the process step 182, a process step 188 occurs. If the “NO” response 186 follow the process step 182, a process step 198 occurs.

The process step 188 inquires whether the administrator 384 wishes to use a predefined template for the new action. As described herein, a predefined template can consist of software-defined actions or prior administrator-created actions. A “YES” response 190 or a “NO” response 192 (e.g., the administrator 384 wishes to build an action from scratch) follow the process step 188. If the “YES” response 190 follow the process step 188, a process step 194 occurs. If the “NO” response 192 follow the process step 188, a process step 196 occurs.

If the administrator 384 chooses to use a predefined template (e.g., the “YES” response 190), the process step 194 occurs where the system properties are pre-populated where possible. The administrator 384 then fills in any additional properties required. For example, the administrator 384 can drag the appropriate action into the workflow editor at the desired step. There may be system properties defined in the action template and these can either be prepopulated or the administrator 384 can fill them in. Some system properties may be connection paths/URLs, usernames, passwords, etc..

Distinctly, if the “NO” response 192 follow the process step 188, the process step 196 includes the administrator 384 choosing a supporting scripting language for the new action.

If the “NO” response 186 follow the process step 182, a process step 198 occurs where the administrator 384 is prompted as to whether the workflow should be saved. A “YES” response 202 or a “NO” response 200 follows the process step 198. If the “YES” response 202 follows the process step 198, a process step 206 occurs, where the workflow is saved. If the “NO” response 200 follows the process step 198, a process step 204 occurs where the workflow is discarded.

A process step 208 follows the process step 194, as shown in FIG. 4B. For each action, the administrator 384 can define whether approval is required for the action to initiate (e.g., the process step 208). A “YES” response 210 or a “NO” response 212 follows the process step 208.

If approval is required (e.g., the “YES” response 210), the administrator 384 can specify which user/group is required to approve the request and if the approval is required (e.g., a process step 214). It should be appreciated that the approval can be set at the workflow level or on the individual action. Then, a process step 216 follows the process step 214, which includes the administrator 384 entering pass/fail notification criteria so that the designated user/group will be notified if the action (e.g., the action 316) is successful or if the job fails. A process step 218 follows the process step 216 and includes the action definition being complete.

Further, the process step 216 and the process step 218 follow the “NO” response 212. The administrator 384 can also assign approvals and pass/fail notifications to the action (e.g., the action 316) (e.g., process steps 208, 210, 212, 214, 216, and 218).

Following the process step 196, a process step 220 occurs where the administrator 384 defines parameters for the new action and marks them as system parameters or user input. These parameters can be system parameters and will be specified by the administrator 384 during workflow development or action execution.

A process step 222 follows the process step 220 and includes the administrator 384 writing logic to create the action (e.g., the action 316) and uploading any required libraries/executables to support the action (e.g., the action 316) created. Some actions may require third-party libraries to execute. In this event, the administrator 384 can upload any required libraries/executables for the action (e.g., the action 316) to complete successfully. Further, a process step 224 follows the process step 222 and includes inquiring whether approval is required.

A “YES” response 226 or a “NO” response 228 follows the process step 224. If the “YES” response 226 follows the process step 224, a process step 230 occurs. If the “NO” response 228 follows the process step 224, a process step 232 occurs. The process step 230 includes the administrator 384 specifying the required user or group where approval is needed. The approval can be set at the workflow level or on the individual action. The process step 232 includes the administrator 384 entering pass/fail notification criteria. It should be appreciated that the process step 232 follows the process step 230.

A process step 234 follows the process step 232, where the administrator 384 is queried as to whether the action (e.g., the action 316) should be saved as a template action, so that it can be reused in other workflows. A “YES” response 238 or a “NO” response 236 follows the process step 234. If the “YES” response 238 follows the process step 234, a process step 240 occurs. If the “NO” response 236 follows the process step 234, a process step 242 occurs. The process step 240 includes the action definition being saved as a template. The process step 242 includes the action definition being complete. The process step 242 follows the process step 240. Moreover, the process step 218 follows the process step 242.

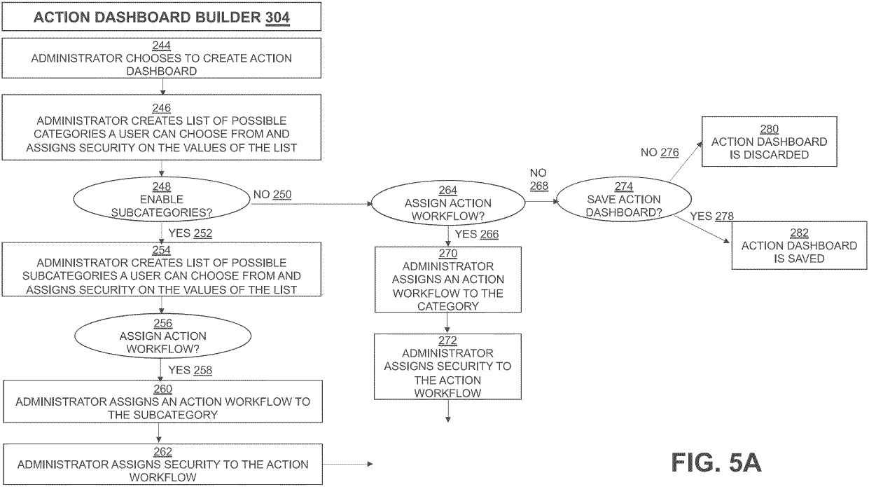

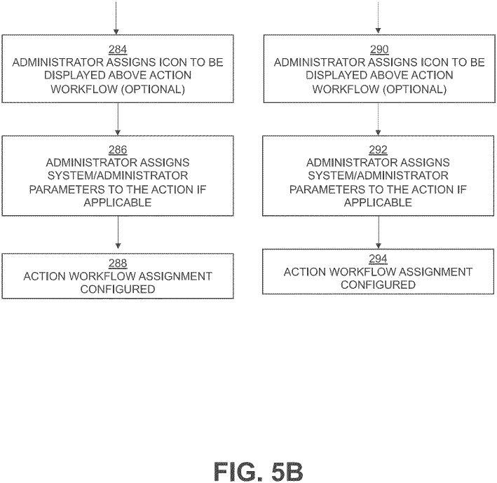

FIG. 5A and FIG. 5B depict process steps that occur when the user 102 engages with the action dashboard builder 304. It should be appreciated that FIG. 5B is a continuation of FIG. 5A.

As shown in FIG. 5A and FIG. 5B, the administrator 384 also has the ability to build action/workflow dashboards for end users (e.g., customers 382) to use to request action/workflow execution. The administrator 384 can create an action dashboard from a menu in the support desk (e.g., a process step 244). Actions (e.g., the actions 316) can be grouped into categories and subcategories to make them easier to find. The administrator 384 can create a list of possible values for the category (e.g., a process step 246). Security can also be applied to each category value so that certain users/groups only have access to select certain values. Subcategories can also be enabled (e.g., a process step 248) for the action dashboard to allow an additional level of filtering.

If the administrator 384 enables subcategories (e.g., a “YES” response 252 to the process step 248), the administrator 384 can create a list of possible subcategory values (at a process step 254). The subcategories can be conditioned on the category value so that the subcategory only displays for certain category values. Security can also be applied on subcategory values so that certain users/groups can only select certain subcategory values. Once categories and subcategories have been set, the user 102 is prompted as to whether the user 102 wishes to assign the action workflows to categories and subcategories (e.g., a process step 256).

If a YES” response 258 occurs to the process step 256, a process step 260 occurs, where the administrator 384 assigns the action workflow to the subcategory. A process step 262 follows the process step 260 and includes the administrator 384 assigning security to the action workflow. The security can be applied on individual action workflows so that certain users can request selected actions.

As an optional step, a process step 284 may follow the process step 262. At the optional process step 284 the administrator 384 may assign icons to be displayed above the workflow. Further, the administrator 384 can also set the system or administrator parameters required for the action, such as connection information (e.g., a process step 286). Then, the action workflow assignment is configured at a process step 288.

If the “NO” response 250 follows the process step 248, a process step 264 occurs where the administrator 384 is queried as to whether the administrator 384 wishes to assign the action workflow. A “YES” response 266 or a “NO” response 286 follow the process step 264. If the “YES” response 266 follows the process step 264, a process step 270 occurs where the administrator 384 assigns an action workflow to the category. A process step 272 follows the process step 270, where the administrator 384 assigns security to the action workflow.

Then, a process step 290 follows the process step 270, where the administrator 384 optionally assigns an icon to be displayed above the action workflow. A process step 292 follows the process step 290 and includes the administrator 384 assigning system/administrator parameters to the action 316 if applicable. Further, a process step 294 follows the process step 292 and includes the action workflow assignment being configured.

If the “NO” response 268 follows the process step 264, a process step 274 occurs where the administrator 384 is queried as to whether the action 316 should be saved to the dashboard. A “YES” response 278 or a “NO” response 276 follow the process step 274. If the “YES” response 278 follows the process step 274, a process step 282 occurs, where the action dashboard is saved. If the “NO” response 276 follows the process step 274, a process step 280 occurs, where the action dashboard is discarded.

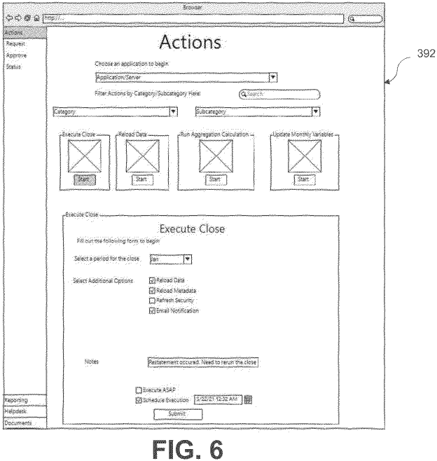

FIGS. 6 - 9 depict software renderings of the instant invention. Specifically, FIG. 6 depicts a rendering of a user interface 392 where the user 102 can request various actions in their applications. The user 102 may filter the applicable actions by category and/or subcategory. After choosing the action 316, the user 102 provides all of the required information, which can range from user selection, user input, or defaulted values. The user 102 can choose to execute the action 316 as soon as possible or on a desired date/time. Once the user 102 submits the action 316, it will go to the appropriate user/group for approval (if applicable) and then will be executed on the desired schedule.

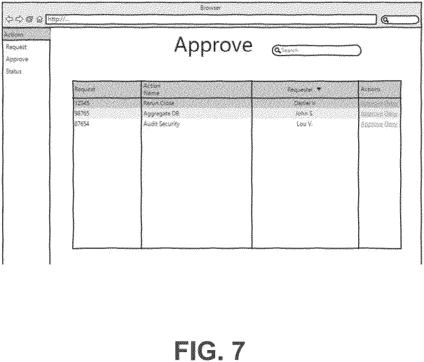

FIG. 7 depicts a rendering of action approval. All users designated as approvers 320 will be able to monitor all outstanding actions that they have security access to see. From a menu, the approvers 320 can see all outstanding requests and be able to approve or deny each request. The approver 320 will receive an email notification when a request requires his/her approval. Notes can be submitted along with an approval or denial action to indicate why the request was approved or denied. The requester will see the approval/denial via an email notification along with the rationale provided by the approver 320.

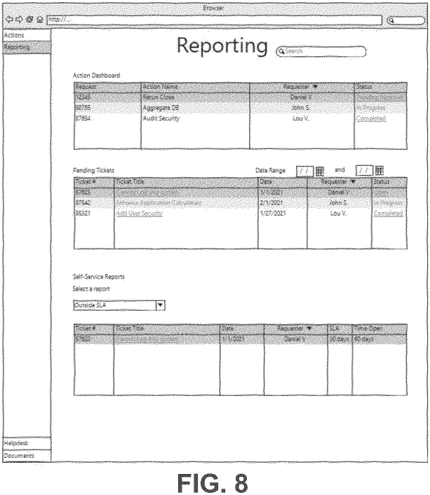

FIG. 8 depicts a rendering of action reporting. All users/administrators have access to a reporting menu item with basic and advanced reporting capabilities. The user 102 will see an action dashboard with any requests that have been submitted along with their status. Any manual tickets that are entered into the ticketing system will be visible from the reporting screen, along with the latest status. There are also self-service reporting capabilities, such as which tickets are exceeding the SLA and the time allowed for contact and/or resolution once a ticket has been opened. The user 102 also has the ability to create custom reports to be able to audit changes to the system over time, such as which actions were performed in the last 30 days.

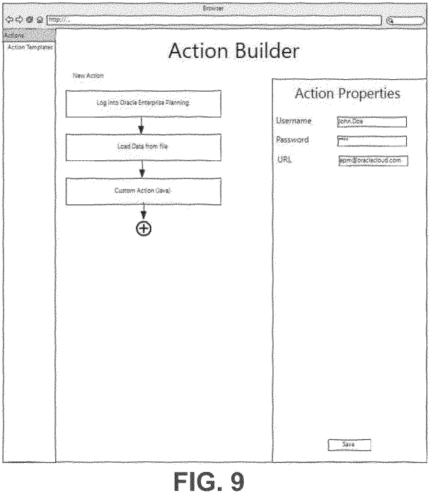

FIG. 9 depicts action workflow builder. Administrators 384 can define custom actions via the action builder. The action builder allows the administrator 384 to define a series of steps/scripts to be run that make up certain actions. An example of this is performing a financial close in an application. The administrator 384 can break down the close process into a series of steps required to perform the close. For example, the action 316 could log into the environment, load data from a file, and then perform a series of calculations or other actions. The steps within the action 316 can be custom, where the administrator 384 would be required to enter scripting or code in order to perform the step. The steps can also be loaded from a predefined template where the administrator 384 can fill out a series of prompts/parameters to configure the template for the intended purpose. Approvals can be set on the action 316 or on individual steps within the action 316. Each step can have a series of parameters that can be coded into the action 316 itself, or prompted for the end user 102 to fill out. Any prompted parameters would be passed into the action 316 when it executes.

Thus, as described, the present invention provides the web server platform 112 that is an all-in-one service desk system. Through the web server platform 112, the user 102 may request predefined jobs, view action/job history, and view the upcoming scheduling of jobs, while having auditable results so that the user 102 can view every request made in the system. The system described herein also allows the user 102 to receive instantaneous support 24/7 without having to create a support ticket, wait for a support agent to claim the ticket, and then wait for the support agent to perform the work.

Further, the system described herein monitors, in real-time, the status of requests, as well as any actions 316 being performed, without having to dig through email notifications on whether a job has been completed. The web server platform 112 also audits all changes to a technology system along with the user 102 who requested the change(s). Moreover, the system provides targeted notifications if the job failed, rather than a generic email blast to all system administrators.

The web server platform 112 also defines approval processes so that tickets get approved before being assigned to support agents, which minimizes the time a support agent needs to wait before being able to work on a support request. Moreover, the system automates common requests to minimize the number of tickets sitting in a support agents’ queue, which improves customer service since routine requests can be pushed through with minimal to no human intervention.

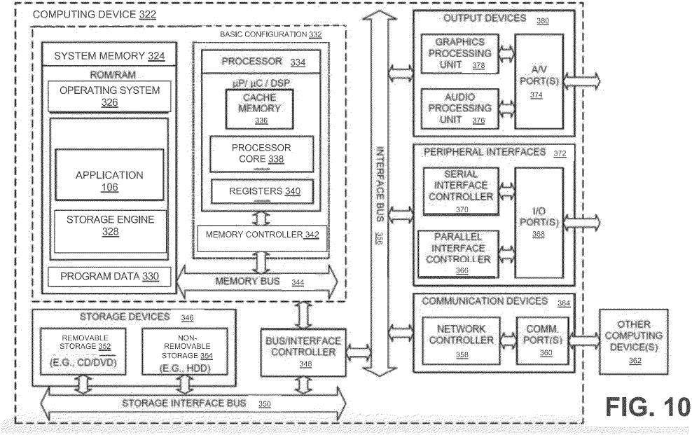

FIG. 10 is a block diagram of a computing device included within the computer system of FIG. 1 that is configured to implement one or more methods, in accordance with embodiments of the present invention.

In some embodiments, the present invention may be a computer system, a method, and/or the computing device 104 (of FIG. 1) or the computing device 322 (of FIG. 10). For example, the computer system and/or the computing device 322 may be utilized to implement one or more methods described herein.

A basic configuration 332 of a computing device 322 is illustrated in FIG. 10 by those components within the inner dashed line. In the basic configuration 332 of the computing device 322, the computing device 322 includes a processor 334 and a system memory 324. In some examples, the computing device 322 may include one or more processors and the system memory 324. A memory bus 344 is used for communicating between the one or more processors 334 and the system memory 324.

Depending on the desired configuration, the processor 334 may be of any type, including, but not limited to, a microprocessor (µP), a microcontroller (µC), and a digital signal processor (DSP), or any combination thereof. Further, the processor 334 may include one more levels of caching, such as a level cache memory 336, a processor core 338, and registers 340, among other examples. The processor core 338 may include an arithmetic logic unit (ALU), a floating point unit (FPU), and/or a digital signal processing core (DSP Core), or any combination thereof. A memory controller 342 may be used with the processor 334, or, in some implementations, the memory controller 342 may be an internal part of the memory controller 342.

Depending on the desired configuration, the system memory 324 may be of any type, including, but not limited to, volatile memory (such as RAM), and/or non-volatile memory (such as ROM, flash memory, etc.), or any combination thereof. The system memory 324 includes an operating system 326, one or more applications, such as the application 106, and program data 330. The system memory 324 may also include a storage engine 328 that may store any information disclosed herein.

Moreover, the computing device 322 may have additional features or functionality, and additional interfaces to facilitate communications between the basic configuration 332 and any desired devices and interfaces. For example, a bus/interface controller 348 is used to facilitate communications between the basic configuration 332 and data storage devices 346 via a storage interface bus 350. The data storage devices 346 may be one or more removable storage devices 352, one or more non-removable storage devices 354, or a combination thereof. Examples of the one or more removable storage devices 352 and the one or more non-removable storage devices 354 include magnetic disk devices (such as flexible disk drives and hard-disk drives (HDD)), optical disk drives (such as compact disk (CD) drives or digital versatile disk (DVD) drives), solid state drives (SSD), and tape drives, among others.

In some embodiments, an interface bus 356 facilitates communication from various interface devices (e.g., one or more output devices 380, one or more peripheral interfaces 372, and one or more communication devices 364) to the basic configuration 332 via the bus/interface controller 356. Some of the one or more output devices 380 include a graphics processing unit 378 and an audio processing unit 376, which are configured to communicate to various external devices, such as a display or speakers, via one or more A/V ports 374.

The one or more peripheral interfaces 372 may include a serial interface controller 370 or a parallel interface controller 366, which are configured to communicate with external devices, such as input devices (e.g., a keyboard, a mouse, a pen, a voice input device, or a touch input device, etc.) or other peripheral devices (e.g., a printer or a scanner, etc.) via one or more I/O ports 368.

Further, the one or more communication devices 364 may include a network controller 358, which is arranged to facilitate communication with one or more other computing devices 362 over a network communication link via one or more communication ports 360. The one or more other computing devices 362 include servers, the database, mobile devices, and comparable devices.

The network communication link is an example of a communication media. The communication media are typically embodied by the computer-readable instructions, data structures, program modules, or other data in a modulated data signal, such as a carrier wave or other transport mechanism, and include any information delivery media. A “modulated data signal” is a signal that has one or more of its characteristics set or changed in such a manner as to encode information in the signal. By way of example, and not limitation, the communication media may include wired media (such as a wired network or direct-wired connection) and wireless media (such as acoustic, radio frequency (RF), microwave, infrared (IR), and other wireless media). The term “computer-readable media,” as used herein, includes both storage media and communication media.

It should be appreciated that the system memory 324, the one or more removable storage devices 352, and the one or more non-removable storage devices 354 are examples of the computer-readable storage media. The computer-readable storage media is a tangible device that can retain and store instructions (e.g., program code) for use by an instruction execution device (e.g., the computing device 322). Any such, computer storage media is part of the computing device 322.

The computer readable storage media/medium can be a tangible device that can retain and store instructions for use by an instruction execution device. The computer readable storage media/medium may be, for example, but is not limited to, an electronic storage device, a magnetic storage device, an optical storage device, an electromagnetic storage device, and/or a semiconductor storage device, or any suitable combination of the foregoing. A non-exhaustive list of more specific examples of the computer readable storage media/medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and/or a mechanically encoded device (such as punch-cards or raised structures in a groove having instructions recorded thereon), and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Aspects of the present invention are described herein regarding illustrations and/or block diagrams of methods, computer systems, and computing devices according to embodiments of the invention. It will be understood that each block in the block diagrams, and combinations of the blocks, can be implemented by the computer-readable instructions (e.g., the program code).

The computer-readable instructions are provided to the processor 334 of a general purpose computer, special purpose computer, or other programmable data processing apparatus (e.g., the computing device 322) to produce a machine, such that the instructions, which execute via the processor 334 of the computer or other programmable data processing apparatus, create means for implementing the functions/acts specified in the block diagram blocks. These computer-readable instructions are also stored in a computer-readable storage medium that can direct a computer, a programmable data processing apparatus, and/or other devices to function in a particular manner, such that the computer-readable storage medium having instructions stored therein comprises an article of manufacture including instructions, which implement aspects of the functions/acts specified in the block diagram blocks.

The computer-readable instructions (e.g., the program code) are also loaded onto a computer (e.g. the computing device 322), another programmable data processing apparatus, or another device to cause a series of operational steps to be performed on the computer, the other programmable apparatus, or the other device to produce a computer implemented process, such that the instructions, which execute on the computer, the other programmable apparatus, or the other device, implement the functions/acts specified in the block diagram blocks.

Computer readable program instructions described herein can also be downloaded to respective computing/processing devices from a computer readable storage medium or to an external computer or external storage device via a network (e.g., the Internet, a local area network, a wide area network, and/or a wireless network). The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user’s computer/computing device, partly on the user’s computer/computing device, as a stand-alone software package, partly on the user’s computer/computing device and partly on a remote computer/computing device or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to block diagrams of methods, computer systems, and computing devices according to embodiments of the invention. It will be understood that each block and combinations of blocks in the diagrams, can be implemented by the computer readable program instructions.

The block diagrams in the Figures illustrate the architecture, functionality, and operation of possible implementations of computer systems, methods, and computing devices according to various embodiments of the present invention. In this regard, each block in the block diagrams may represent a module, a segment, or a portion of executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block and combinations of blocks can be implemented by special purpose hardware-based systems that perform the specified functions or acts or carry out combinations of special purpose hardware and computer instructions.

Another embodiment of the invention provides a method that performs the process steps on a subscription, advertising, and/or fee basis. That is, a service provider can offer to assist in the method steps described herein. In this case, the service provider can create, maintain, and/or support, etc. a computer infrastructure that performs the process steps for one or more customers. In return, the service provider can receive payment from the customer(s) under a subscription and/or fee agreement, and/or the service provider can receive payment from the sale of advertising content to one or more third parties.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others or ordinary skill in the art to understand the embodiments disclosed herein.

When introducing elements of the present disclosure or the embodiments thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system comprising:
a computing device comprising:
one or more processors;
one or more memories;
one or more computer-readable hardware storage devices; and
a graphical user interface (GUI) configured to receive an action from a user to access a self-service support desk platform;
a communication channel that connects the computing device and the self-service support desk platform; and
the self-service support desk platform being configured to:
receive a selection, from the user, of a predefined service request;
receive, from the user, an execution date for the predefined service request and
information regarding a rationale for submitting the predefined service request;
automatically creating a support ticket that comprises the information;
assigning the support ticket to a system group;
in response to a determination that an approval is required from an approver for execution of an action associated with the support ticket;
automatically directing the support ticket to the approver; and
notifying the approver that the approval is required;
in response to receiving the approval, automatically scheduling the execution of the action associated with the support ticket for the execution date;
on the execution date, executing the action associated with the support ticket; and
in response to a determination of a successful completion of the action, updating and closing the support ticket.

2. The system of claim 1, wherein the GUI of the computing device is further configured to:
receive login credentials from a user; and
query a database to determine an identity of the user and an access level to the self-service support desk platform for the user based on the login credentials.

3. The system of claim 2,
wherein the identity of the user comprises a customer or an administrator, and
wherein the access level comprises a first access level or a second access level.

4. The system of claim 3, wherein the second access level is greater than the first access level such that the second access level provides the user a larger number of actions with respect to the self-service support desk platform as compared to the first access level.

5. The system of claim 1, wherein the execution date for the predefined service request is a current time and date or a future time and date.

6. The system of claim 1, wherein the GUI of the computing device is further configured to:
receive a request from the user to search support tickets via the self-service support desk platform.

7. The system of claim 6, wherein a subset of the support tickets comprise a Service Level Agreement (SLA).

8. The system of claim 1, wherein, in response to a determination that the approver failed to approve the execution of the action associated with the support ticket, the self-service support desk platform is further configured to: close the support ticket automatically with a message that the action associated with the support ticket was not approved.

9. The system of claim 1, wherein, in response to a determination of an unsuccessful completion of the action,
automatically updating the support ticket as having failed;
determining a location where the action failed; and
assigning the support ticket to a group associated with the location where the action failed.

10. The system of claim 1, wherein the self-service support desk platform further comprises a self-service reporting dashboard.

11. The system of claim 10, wherein the user is configured to engage the self-service reporting dashboard to view information selected from the group consisting of: a status of an action in progress, an action history, a status of a support ticket, and a history associated with the support ticket.

12. A method executed by a system, the system comprising a computing device, a communication channel, and a self- service support desk platform, the method comprising:
receiving, via a graphical user interface (GUI) of a computing device, an action from a user to access a self-service support desk platform, wherein a communication channel connects the computing device and a self-service support desk platform;
receiving, via the self-service support desk platform and from the user, a selection of a predefined service request;
receiving, via the self-service support desk platform and from the user, an execution date for the predefined service request and information regarding a rationale for submitting the predefined service request;
automatically creating, via the self-service support desk platform, a support ticket that comprises the information;
assigning, via the self-service support desk platform, the support ticket to a system group;
in response to a determination that an approval is required from an approver for execution of an action associated with the support ticket,
automatically directing, via the self-service support desk platform, the support ticket to the approver; and
notifying, via the self-service support desk platform, the approver that the approval is required;
in response to receiving the approval, automatically scheduling, via the self-service support desk platform, the execution of the action associated with the support ticket for the execution date;
on the execution date, executing, via the self-service support desk platform, the action associated with the support ticket; and
in response to a determination of a successful completion of the action, updating and closing, via the self-service support desk platform, the support ticket.

13. The method of claim 12, wherein, in response to a determination that the approver failed to approve the execution of the action associated with the support ticket, the method further comprises closing, via the self-service support desk platform, the support ticket automatically with a message that the action associated with the support ticket was not approved.

14. The method of claim 12, wherein in response to a determination of an unsuccessful completion of the action, the method further comprises:
automatically updating, via the self-service support desk platform, the support ticket as having failed;
determining, via the self-service support desk platform, a location where the action failed; and
assigning, via the self-service support desk platform, the support ticket to a group associated with the location where the action failed.

15. The method of claim 12,
wherein the user comprises an administrator, and
wherein the method further comprises:
receiving, from the administrator and through an administrator action builder of the self-service support desk platform, a creation of a new action;
receiving, from the administrator and through the administrator action builder, security settings for the new action; and
determining if the administrator is using a predefined template for the new action.

16. The method of claim 15, wherein, in response to a determination that the administrator is using the predefined template for the new action, the method further comprises: pre-populating, through the administrator action builder, system properties and receiving, from the administrator, additional properties.

17. The method of claim 16, further comprising:
determining, via the administrator action builder, if an approval is required for the new action;
in response to a determination that the approval is not required for the new action, receiving, from the administrator and through the administrator action builder, pass/fail notification criteria; and
in response to a determination, from the administrator and through the administrator action builder, that the new action is to be saved as a template, saving the new action as the template.

18. The method of claim 15, further comprising:
in response to a determination that the administrator is not using the predefined template for the new action, receiving, from the administrator and through the administrator action builder, a supporting scripting language for the new action;
receiving, from the administrator and through the administrator action builder, definitions of parameters for the new action; and
receiving, from the administrator and through the administrator action builder, logic to create the new action and libraries and executables to support the new action.

19. The method of claim 18, further comprising:
determining, via the administrator action builder, if an approval is required for the new action;
in response to a determination that the approval is not required for the new action, receiving, from the administrator and through the administrator action builder, pass/fail notification criteria; and
in response to a determination, from the administrator and through the administrator action builder, that the new action is to be saved as a template, saving the new action as the template.

20. The method of claim 12, further comprising:
building, by the administrator and through an action dashboard builder, action/workflow dashboards for end users to use to request action/workflow execution.
